(19) United States
(12) Patent Application Publication
(10) Pub. No.: US 2006/0013764 A1
(43) Pub. Date: Jan. 19, 2006

(54) Process for the production of high purity hydrogen from a catalytic reformer

(76) Inventors: Lance A. Baird, Prospect Heights, IL (US); Thomas J. Gevelinger, Oak Brook, IL (US)

Correspondence Address: JOHN G TOLOMEI, PATENT DEPARTMENT;UOP LLC, 25 EAST ALGONQUIN ROAD, P O BOX 5017, DES PLAINES, IL, 60017-5017, US

(21) Appl. No.: 10/747,717

(22) Filed: Dec. 29, 2003

(51) Int. Cl. C01B 3/26

(52) U.S. Cl. 423/652

(57) ABSTRACT

A process for the production of high purity hydrogen from a naphtha catalytic reformer wherein the reformer is firstly operated at a predetermined catalyst circulation rate to produce hydrogen gas containing carbon monoxide and secondly the catalyst circulation rate is reduced to produce hydrogen gas having a lower concentration of carbon monoxide.

### FIELD OF THE INVENTION

This invention relates generally to the production of high purity hydrogen from a catalytic reformer. Certain uses require extremely high purity hydrogen which can be supplied by the instant invention.

### BACKGROUND OF THE INVENTION

Net hydrogen gas from a catalytic naphtha reforming process is a very useful source of high-purity hydrogen in the modem petroleum refinery. In some cases, when reformers are operated at severe operating conditions, the net hydrogen gas, unfortunately, contains trace amounts of carbon monoxide, for example, up to 100 vppm. Furthermore, the optimum value for the reforming process variables to minimize carbon monoxide concentration in the net hydrogen gas are in the opposite direction from the optimum for the reformer process yield and selectivity. For example, low operating pressure in the reforming process maximizes the liquid product yield but maximizes carbon monoxide production, and high operating temperature in the reforming process maximizes the octane of the liquid product but also maximizes carbon monoxide production. Carbon monoxide is a catalyst poison for many different catalysts used in refinery processes using hydrogen make-up gas. In particular, it is a poison for the catalyst used in low molecular weight paraffin isomerization processes. Consequently, it is highly desirable to find a means of eliminating carbon monoxide from naphtha catalytic reforming net hydrogen gas.

The net hydrogen gas is primarily hydrogen and its high purity makes it ideal for use in hydrotreating, hydrocracking and paraffin isomerization units which are typically present in the modem refinery. The process variables in the reforming unit are typically adjusted to maximize the reformate liquid product yield while maintaining the target octane. The temperature in the reforming unit is adjusted to reach the target product octane. The reforming unit pressure is kept as low as possible because the liquid yield is highest at low pressure. Advances in the reforming process and reforming catalyst have enabled operation at lower and lower pressure, so that current operation at 450 kPa (50 psig) and lower is possible.

The operating conditions in the catalytic reforming reactors are similar to those employed in the classic steam reforming process to produce hydrogen. Unfortunately, this means that carbon monoxide is formed in the reforming reactors and becomes a trace impurity in the net hydrogen off-gas when undesirable levels of moisture are present. The problem is that advances in the reforming process and catalyst, in particular reforming units utilizing continuous catalyst regeneration, have enabled operation at reaction conditions where yield and selectivity are near optimum, but this has also unexpectedly caused the concentration of carbon monoxide in the reformer net hydrogen off-gas to increase to significant levels. Paraffin isomerization catalysts are the most sensitive to the presence of carbon monoxide. The paraffin isomerization catalyst is poisoned by the water formed from the carbon monoxide when it is reacted with hydrogen in the isomerization reactor. Concentrations as small as 1 vppm carbon monoxide in the hydrogen make-up gas cause significant deactivation of isomerization catalyst. Furthermore, the isomerization catalyst is not regenerable. Therefore, it is preferable to minimize the concentration of carbon monoxide in the hydrogen make-up gas to an isomerization unit to less than 1 vppm if possible.

### INFORMATION DISCLOSURE

U.S. Pat. No. 6,117,809 (Sechrist et al.) describes in detail a moving bed catalytic naphtha reforming unit.

### BRIEF SUMMARY OF THE INVENTION

The present invention is a process for the production of high purity hydrogen containing essentially no carbon monoxide from a catalytic reformer. The catalytic reformer has at least one reforming zone wherein the catalyst is continuously moved downwardly through the reforming zone. Fresh or regenerated reforming catalyst is introduced into the top of the reforming zone to replace spent reforming catalyst which is removed from the bottom of the reforming zone. The downwardly moving flow rate of reforming catalyst is established at a rate to produce a net hydrogen product stream containing carbon monoxide and thereafter the flowing rate of reforming catalyst through the reforming zone is reduced to subsequently produce a net hydrogen product having a significantly reduced concentration of carbon dioxide.

Other embodiments of the present invention encompass further details such as descriptions of feedstocks, catalytic reformers, reforming catalyst and preferred operating conditions, all of which are hereinafter disclosed in the following discussion of each of these facets of the invention.

### DETAILED DESCRIPTION OF THE INVENTION

This invention is used to produce a high purity hydrogen stream containing essentially no carbon monoxide in a naphtha catalytic reformer. Catalytic reforming is a well established hydrocarbon conversion process employed in the petroleum refining industry for improving the octane quality of hydrocarbon feedstocks, the primary product of reforming being motor gasoline. The art of catalytic reforming is well known and does not require detailed description herein.

Briefly, in catalytic reforming, a feedstock is admixed with a recycle stream comprising hydrogen and contacted with catalyst in a reaction zone. The usual feedstock for catalytic reforming is a petroleum fraction known as naphtha and having an initial boiling point of about 82° C. (180° F.) and an end boiling point of about 204° C. (400° F.). The catalytic reforming process is particularly applicable for the treatment of straight run gasolines comprised of relatively large concentrations of naphthenic and substantially straight chain paraffinic hydrocarbons, which are subject to aromatization through dehydrogenation and/or cyclization reactions. Reforming may be defined as the total effect produced by dehydrogenation of cyclohexanes and dehydroisomerization of alkylcyclopentanes to yield aromatics, dehydrogenation of paraffins to yield olefins, dehydrocyclization of paraffins and olefins to yield aromatics, isomerization of n-paraffins, isomerization of alkylcycloparaffins to yield cyclohexanes, isomerization of substituted aromatics, and hydrocracking of paraffins. Further information and description of reforming processes may be found in, for example, U.S. Pat. No. 6,034,018 (Sechrist et al.).

A catalytic reforming reaction is normally effected in the presence of catalyst particles comprised of one or more Group VIII noble metals (e.g., platinum, iridium, rhodium, and palladium) and a halogen combined with a porous carrier, such as a refractory inorganic oxide. The halogen is normally chloride. Alumina is a commonly used carrier. The preferred alumina materials are known as gamma, eta, and theta alumina, with gamma and eta alumina giving the best results. An important property related to the performance of the catalyst is the surface area of the carrier. Preferably, the carrier will have a surface area of from 100 to about 500 m²/g. The particles are usually spheroidal and have a diameter of from about 1/16 to about ⅛ inch (1.6-3.2 mm), though they may be as large as ¼ inch (6.35 mm). In a particular regenerator, however, it is desirable to use catalyst particles which fall in a relatively narrow size range. A preferred catalyst particle diameter is 1/16 inch (1.6 mm). During the course of a reforming reaction, catalyst particles become deactivated as a result of mechanisms such as the deposition of coke on the particles; that is, after a period of time in use, the ability of catalyst particles to promote reforming reactions decreases to the point that the catalyst is no longer useful. The catalyst must be regenerated before it can be reused in a reforming process.

The present invention is applicable to a reforming process with at least one moving-bed reforming reaction zone and at least one moving-bed catalyst regeneration zone. This invention is applied to a reforming process with a moving bed reaction zone and a moving bed regeneration zone. Generally three or four reaction zones are operated in series with reheating between each zone. Regenerated catalyst particles are fed to a reaction zone, which may be comprised of several subzones, and the particles flow through the zone by gravity. Catalyst is withdrawn from the bottom of the reaction zone and transported to a regeneration zone. Catalyst that is withdrawn from the reaction zone is termed spent catalyst. In the regeneration zone, a multi-step regeneration process is used to regenerate the catalyst to restore its full reaction promoting ability. Catalyst flows by gravity through the various regeneration steps and then is withdrawn from the regeneration zone and furnished to the reaction zone. Catalyst that is withdrawn from the regeneration zone is known as regenerated catalyst. Arrangements are provided for adding fresh catalyst as make-up to and for withdrawing spent catalyst from the process. Movement of catalyst through the zones is often referred to as continuous, though in practice, it is semicontinuous. By semicontinuous movement it is meant the repeated transfer of relatively small amounts of catalyst at closely spaced points in time. For example, one batch every twenty minutes may be withdrawn from the bottom of a reaction zone and withdrawal may take five minutes, that is, catalyst will flow for five minutes. A moving bed system has the advantage of maintaining production while the catalyst is removed or replaced.

Although the multi-step regeneration process that is used to regenerate the catalyst often comprises three, four, or more individual steps, for the purposes of describing this invention the regeneration process can be thought of generally as comprising two steps, an oxidation step and a reduction step. The oxidation step produces oxidized catalyst having at least a portion of its metal with an oxidation number greater than zero. It is uncommon in reforming catalyst regeneration processes that the operating conditions of the oxidation step effect only oxidation of the metal and have no other effect on the catalyst. Nevertheless, the metal of a catalyst that is in a reduced state may be oxidized by contacting the catalyst with a stream containing an oxidizing agent, and the oxidizing agent and the oxidizing conditions can be selected by persons of ordinary skill in the art so that the reaction which oxidizes the metal is promoted and any other reactions or effects on the catalyst are minimized.

It is more common in reforming catalyst regeneration processes, however, that the operating conditions of the oxidation step are selected primarily to achieve some purpose other than oxidation of the metal, and oxidation of the metal is a side reaction, an ancillary effect, or an intermediate step. For example, the oxidation step may comprise a coke combustion step in which the coke on a spent reforming catalyst is combusted by contacting the catalyst with a hot circulating gas stream containing a low concentration of oxygen. Although the main purpose of a coke combustion step is to oxidize the coke deposits, the combustion conditions are generally sufficient to oxidize the metal on the catalyst as well. Another example of an oxidation step is a metal dispersion step, in which agglomerated metal on a reforming catalyst is dispersed by contacting the catalyst with a hot stream containing chlorine and oxygen. Generally, the redispersion conditions are sufficient to oxidize or to further oxidize, metal on the catalyst, even if the catalyst has undergone a prior coke combustion step. A third example of an oxidation step is a drying step in which a reforming catalyst is dried to remove water by contacting the catalyst with a hot stream containing oxygen, such as air. In theory, such drying conditions are sufficient not only to remove water from the catalyst but also to oxidize the metal on the catalyst. In practice, however, such a drying step is not performed on a catalyst unless the catalyst has already undergone either a coke combustion step, a metal redispersion step, or both, and thus some of the metal on the catalyst that is to be dried may be already partially or fully oxidized. Accordingly, the extent to which such a subsequent drying step can or will oxidize the catalyst may be limited. Nevertheless, the catalyst that exits a drying step that employs hot air as the drying medium generally has its metal in an oxidized state.

The reduction step produces reduced catalyst having its metal in an oxidation state that is lower or reduced relative to the oxidation state of the metal on the catalyst from the oxidation step. It is common in reforming catalyst regeneration processes that the operating conditions of the reduction step are selected primarily to reduce the metal to an oxidation number of zero, even though other side reactions or collateral effects may occur on the catalyst during the reduction step. The kinds of reactions and other effects that occur on the catalyst depend on several factors including the composition of the catalyst, the reduction conditions, the arrangement of the reduction zone, and the reducing agent. Although C₁-C₅ hydrocarbons and even carbon monoxide can in principle be used as a reducing agent, the most widely used agent for reducing the metal of reforming catalysts is molecular hydrogen. Accordingly, the reducing step generally comprises contacting the catalyst with a hot hydrogen-rich gas stream. By hydrogen-rich, it is meant a stream having a concentration of hydrogen generally of more than 50 mol-%, and preferably of more than 75 mol-%. The product separation facilities of a reforming process produces a recycle gas stream having a hydrogen concentration generally of from 65 to 85 mol-% that is typically recycled to the reaction zone and a net gas stream having a hydrogen concentration generally of from 75 to 95 mol-% that is typically not recycled to the reaction zone. The balance of either stream is generally C₁-C₆ paraffinic hydrocarbons. Depending on the conditions and arrangement of the reduction zone, a portion of either stream may be suitable for use as the reduction inlet stream for reducing the reforming catalyst.

Reforming catalysts can be reduced over a wide range of conditions that depend on factors such as the composition of the catalyst, the operating conditions of the reforming process, and the operating conditions of the other steps of the multi-step catalyst regeneration process. Where hydrogen is the reducing agent, the reduction temperatures are maintained typically and preferably in the range of 121°-566° C. (250°-1050° F.) and more preferably in the range of 200-350° C. (392-662° F.) and the reduction pressure is maintained typically in the range of 450-1500 kPa (50-200 psig).

In the case of reforming catalyst particles being reduced by a hydrogen-rich reduction gas, the reduction zone in which the catalyst particles are contacted with the reducing gas can be any of the well known arrangements for contacting solid particles with a gas stream. When using the method of this invention in a continuous or semicontinuous catalyst regeneration zone, the catalyst is contacted with a hot reduction inlet gas stream in a zone and a reduction outlet gas stream is withdrawn from the zone. Where the reduction zone comprises a moving catalyst bed, the direction of the gas flow is preferably countercurrent relative to the direction of movement of the catalyst, but the direction of gas flow can also be cocurrent, crosscurrent, or a combination of countercurrent, cocurrent, and crosscurrent. The shape of the catalyst bed can be rectangular, annular, spherical, or any suitable shape, but the preferred shape is spherical. The distributor for the gas flow to the catalyst bed may be of any suitable type, but preferably it is an annular distributor of the type disclosed in U.S. Pat. No. 4,662,081 (Greenwood) and U.S. Pat. No. 4,665,632 (Greenwood), the teachings of which are incorporated herein by reference.

During the reforming of naphtha in the reforming reaction zone or zones, the operating conditions preferably maintained at a pressure from about 270 kPa (25 psig) to about 1480 kPa (200 psig), a temperature from about 450° C. (842° F.) to about 550° C. (1022° F.), a hydrogen to hydrocarbon mole ratio from about 1 to about 5 and a liquid hourly space velocity from about 0.5 to about 4hr⁻¹. In accordance with the present invention, the catalyst circulation rate is preferably in the range of about 10 g per hour per m³ of fresh feed to about 300 g per hour per m³ of fresh feed.

It has unexpectedly been discovered that in the event that the net hydrogen-rich gas contains undesirable carbon monoxide during the catalytic reforming of naphtha, the concentration of carbon monoxide may be reduced by lowering the catalyst circulation in the reforming reaction zone. Although the regenerated reforming catalyst is dried before being reintroduced into the catalytic reforming zone, under certain operating conditions and for a variety of other reasons the regenerated catalyst is a potential source of moisture which may concomitantly be recycled to the reforming zone. By lowering the catalyst circulation rate, the regeneration and drying zones are in some cases better able to dry the regenerated catalyst and the total moving mass of catalyst including trace quantities of water is lowered. Since oxygenated compounds are converted to carbon monoxide in the reforming zone by means of the above mentioned water gas shift reaction, the undesirable production of carbon monoxide in the hydrogen off-gas may be reduced if not eliminated by preventing or at least minimizing the amount of moisture carried by the regenerated catalyst into the reforming zone.

The present invention is particularly useful and advantageous when the concentration of carbon monoxide in the net hydrogen product is more than about 20 vppm but is also useful when the carbon monoxide concentration is in the range from about 10 vppm to about 20 vppm. By utilizing the present invention, the resulting carbon monoxide concentration in the net hydrogen product is preferably reduced to a level below about 5 vppm and more preferably less than 1 vppm. A preferred net hydrogen product contains a carbon monoxide concentration from about 0.1 to about 20 vppm.

The process of the present invention is further demonstrated by the following example. This example is, however, not presented to unduly limit the process of this invention, but to further illustrate the unexpected result of being able to produce a high purity hydrogen stream containing nil carbon monoxide from a naphtha catalytic reforming unit.

### EXAMPLE

The net hydrogen gas stream from an operating naphtha catalytic reforming unit was sampled and analyzed for carbon monoxide. The hydrogen gas steam contained about 50 vppm carbon monoxide when the catalyst circulation rate was conducted at 100% of design catalyst circulation rate.

The catalyst circulation rate was then reduced to 60% of design catalyst circulation rate and the hydrogen gas stream was found to contain only about 5 vppm carbon monoxide.

The foregoing description and example clearly illustrate the advantages encompassed by the process of the present invention and the benefits to be afforded with the use thereof.

What is claimed is:

1. A catalytic reforming process having a moving bed of reforming catalyst passing through at least one reforming zone at a flow rate to produce a net hydrogen product stream containing carbon monoxide wherein the process comprises determining a concentration of the carbon monoxide in the net hydrogen product stream and reducing the flow rate of the reforming catalyst passing through the reforming zone to thereby reduce the concentration of carbon monoxide in the net hydrogen product stream.

2. The process of claim 1 wherein the catalytic reforming process comprises three reforming zones.

3. The process of claim 1 wherein the catalytic reforming process comprises four reforming zones.

4. The process of claim 1 wherein the reforming catalyst is spherical.

5. The process of claim 1 wherein the net hydrogen product stream having a reduced concentration of carbon monoxide contains from about 0.1 to about 20 vppm carbon monoxide.

6. The process of claim 1 wherein a reduced catalyst circulation rate is in the range from about 10 g/hr/m³ feed to about 300 g/hr/m³ feed.

7. The process of claim 1 wherein the reforming zone is operated at conditions including a pressure from about 270 kPa (25 psig) to about 1480 kPa (200 psig), a temperature from about 450° C. (842° F.) to about 550° C. (1022° F.), a hydrogen to hydrocarbon mole ratio from about 1 to about 5 and a liquid hourly space velocity from about 0.5 to about 4hr⁻¹.

8. A catalytic reforming process having a moving bed of reforming catalyst passing through four reforming zones at a flow rate to produce a net hydrogen product stream containing carbon monoxide wherein the process comprises determining a concentration of the carbon monoxide in the net hydrogen product stream and reducing the flow rate of the reforming catalyst through the reforming zones to thereby reduce the carbon monoxide concentration to less than about 20 vppm in the net hydrogen product stream.

9. The process of claim 8 wherein the reforming catalyst is spherical.

10. The process of claim 8 wherein net hydrogen product stream having a reduced concentration of carbon monoxide contains from about 0.1 to about 10 vppm carbon monoxide.

11. The process of claim 8 wherein a reduced catalyst circulation rate is in the range from about 10 g/hr/m³ feed to about 300 g/hr/m³ feed.

12. The process of claim 8 wherein the reforming zone is operated at conditions including a pressure from about 270 kPa (25 psig) to about 1480 kPa (200 psig), a temperature from about 450° C. (842° F.) to about 550° C. (1022° F.), a hydrogen to hydrocarbon mole ratio from about 1 to about 5 and a liquid hourly space velocity from about 0.5 to about 4hr⁻¹.

13. A catalytic reforming process having a moving bed of spherical reforming catalyst passing through four reforming zones at a flow rate to produce a net hydrogen product stream containing carbon monoxide in an amount greater than about 20 vppm wherein the process comprises determining a concentration of the carbon monoxide in the net hydrogen product stream and reducing the flow rate of the spherical reforming catalyst through the reforming zones to a range from about 10 g/hr./m³ feed to about 300 g/hr./m³ feed to thereby reduce the carbon monoxide concentration to less than about 5 vppm in the net hydrogen product stream.

14. A catalytic reforming process having a moving bed of reforming catalyst passing through at least one reforming zone at a flow rate to produce a net hydrogen product stream containing carbon monoxide wherein the process comprises determining a concentration of the carbon monoxide in the net hydrogen product stream and reducing the moisture content of the reforming catalyst passing through the reforming zone to thereby reduce the concentration of carbon monoxide in the net hydrogen product stream.
